(19) United States
(12) Patent Application Publication
(10) Pub. No.: US 2003/0078838 A1
(43) Pub. Date: Apr. 24, 2003

(54) Method of retrieving advertising information and use of the method

(76) Inventor: Jeffrey P. Szmanda, Milwaukee, WI (US)

Correspondence Address: CHARLES R. SZMANDA, 4 CROSSMAN AVENUE, WESTBOROUGH, MA, 01581, US

(21) Appl. No.: 09/982,640

(22) Filed: Oct. 18, 2001

(51) Int. Cl. G06F 17/60; G06F 17/30

(52) U.S. Cl. 705/14; 707/3

(57) ABSTRACT

This invention relates to a method of retrieving stored information about advertisements, presented in any medium, the use of the method for the purpose of response facilitation and the use of the method for the purpose of performing demographic research.

### FIELD OF THE INVENTION

The present invention generally relates to the field of advertisement response facilitation, and specifically relates to a method of retrieving information about advertisements presented in any medium and the use of the method to facilitate demographic research.

### BACKGROUND OF THE INVENTION

The advent of the Internet has resulted in the ability to communicate data across the globe instantaneously, and will allow for numerous new applications that enhance consumer's lives. One of the enhancements that can occur is the ability of the consumer to retrieve information rapidly that is relevant to his or her lifestyle and interests at any time the consumer wishes, instead of accepting programmed information on media such as radio, television, print, public displays such as billboards, internet banner advertisements and the like.

In particular, advertising captures the consumer's attention at times when the consumer is unable or unwilling to pay sufficient attention to allow retention of potentially useful details such as, but not limited to, product characteristics, price and/or terms of sale, product options, availability, purchase venue, advertiser contact information and brand. In addition, consumers do not necessarily make purchase decisions at the time the advertisement is presented or seen. For example, the consumer might be made aware of the existence of a new product because of an advertisement. The decision to buy that product or to view that product as desirable may require some time after the advertisement is experienced. During such a period of time, referred to herein as the ideation period, details such as those above may be lost from the consumer's memory; the consumer may have only the general perception that the product is desirable or may have formed no perception at all. Nevertheless, the advertising may have made an impression on the consumer. Such an impression may be vague or highly specific. Therefore, a method of accessing the necessary information is required to enable the consumer to (a) refine further his or her impression of the product and/or advertiser, (b) form or enhance his or her perception of the product and/or advertiser, (c) consummate a purchase of the advertiser's product or (d) engage in other behavior or behavior patterns consistent with the interests of the advertiser or intended purpose of the advertisement.

A decision to purchase a product may evolve over the course of the ideation period, even as the consumer's memory of advertised details erodes. Such details comprise product characteristics, price and/or terms of sale, product options, availability, purchase venue, brand and advertiser contact information. It is known in the advertising art that advertisements laden with such detail must be repeated frequently so that consumers can be reminded and retain sufficient information to enable a purchase decision and subsequent consummation of a purchase. However, advertising is done at great expense and unnecessary repetition must be avoided. Thus, it would be desirable to aid consumers by providing a convenient method of information retrieval regarding advertisements so that such details can be provided to consumers at little or no cost to the advertiser and little or no cost to the consumer.

The ideation period may be of short or long duration but, in either case, may culminate in a decision to purchase an advertised product or in the formation of an impression of the product or its producer as a result of experiencing the advertisement. Either or both outcomes may comprise the intended effect of the advertising. In addition, it is sometimes desired by advertisers to influence certain behavior or activity by the consumer. Such behavior or activity may include but is not limited to a commitment or pledge to purchase or make one or more purchases over time, an inquiry about the product or advertiser, an effort to try or sample the product, an investment in securities using the services of a broker or other intermediary, a discussion of the product with associates, a change in opinion about a product or issue, a participation in political activity such as voting in political, corporate or association elections or referenda in a manner favorable to the position of the advertiser or an expression of an opinion to an elected representative for the purpose of influencing his or her actions. It is known in the art that influencing opinions and behavior requires considerable repetition in order that consumers can be reminded of and retain sufficient information to enable decision-making and subsequent follow-through. However, advertising is done at great expense and unnecessary repetition must be avoided. Accordingly, it would be desirable if other means could be provided to obtain information about advertised details so that consumers are able to access such details readily without numerous viewings of the same or similar advertisements.

If the intended outcome of the advertising is to modify purchasing behavior, such advertising can influence the consumer to create a desire or perceived need for a product where there had been no such perceived need or desire previously. Such desire or perceived need may arise after the period of ideation and/or decision making, during which time, the consumer may be influenced unconsciously or consciously by the advertisement to view the advertised product in a favorable light, to desire the product and/or weigh cost and benefits of the product relative to other purchases that might be made. During the course of such a period, potentially useful details such as, but not limited to, product characteristics, price and/or terms of sale, product options, availability, purchase venue, brand and advertiser contact information may be lost or diminished in the consumer's memory, even though the desire for the product has been created. A convenient means of accessing the necessary information is required to enable consummation of the desired outcome by the consumer.

Further, it is not required that the advertisement contain potentially useful details including, but not limited to, product characteristics, price and/or terms of sale, product options, availability, purchase venue, brand and advertiser contact information. For example the advertiser may wish to influence the consumer to decide to purchase the product without actually doing so, in such circumstances as, when the product will become available at a later time, when the consumer requires or desires the product at a later time or when the advertisement is intended to influence the consumer's long-term or continual purchase behavior. As another example, the advertiser may wish the consumer to seek affirmatively the necessary information to enable consummation of the purchase of the advertiser's product. In this way, the consumer is encouraged to be an active rather than a passive participant in the advertising process. In cases where the advertiser provides little or no such detail, a means of accessing the necessary information is required.

In certain circumstances the advertiser may wish to induce the consumer to follow a chain of advertisements in anticipation of gaining successively more information about the product or subject matter being advertised, thus leading the consumer through a sequence of behaviors or decisions that are intended to culminate in the desired outcome. Such outcome may be an overt purchase, a decision to purchase, an overt action such as political or voting activity, a commitment to take action in the future, volunteer activity, or the decision to commit to continual behavior consistent with the intention of the advertiser. At any point in the chain of advertisements, including the endpoint, the consumer may not have gained sufficient information or may not have retained sufficient information to enable consummation of the outcome desired by the advertiser. It is known in the art that the pursuit of such an advertising strategy may require significant repetition, not only of the individual segments but also of the final segment that completes the series. Otherwise, consumers who view the chosen advertising medium less frequently or infrequently may miss critical details and may therefore be unable to consummate a purchase or engage in the desired activity because sufficient information is unavailable. However, if consumers were provided with a convenient method of retrieval of advertising information, they would be able to obtain the necessary information to consummate such a purchase or activity.

It is known in the art of advertising that the advertisement's content is communicated to consumers who are under many different circumstances. Accordingly, the advertiser must compete for the consumer's attention in a way that makes a lasting impression on the consumer's memory. Advertisements that exhibit a high level of salience are known to make lasting impressions on consumers. Such impressions may be either favorable or unfavorable and can be highly precise or vague. In any case, specific details regarding the subject of the advertising may be lost over time, particularly if the consumer is not in a position to respond to the advertisement or delays in making a decision to respond for any reason.

Communication of advertising content is accomplished through media that convey sensory input to the consumer. Without intending to be bound by theory, it is believed that such sensory input can convey levels of meaning, depending on the sense to which the advertiser is appealing. By relying on multiple levels of meaning, the advertiser frequently employs ambiguity so that the message of the advertisement will appeal to the broadest audience that finds the advertisement relevant. In addition, advertisers are known in the art to employ a range of sensory queues that are meant to connect in some way with the consumer's experience. Because consumers come from a wide range of backgrounds, some sensory queues may connect strongly with the consumer's experience while others do not connect at all. Having experienced the advertisement, the consumer may have difficulty describing his or her reaction precisely. Such imprecision is often desirable from the standpoint of the advertiser and frequently inevitable, particularly in circumstances where there is ambiguity about meaning. Various examples are outlined infra.

The visual mode is among the most frequently employed sensory modes used in advertising. Images can be used to attract the attention of the consumer in circumstances when he or she would not ordinarily be inclined to pay attention to the advertisement. It is known that billboards are placed along the busiest roadways in order to be viewed by the largest number of consumers. However, because such a roadway is busy, consumers who are operating motor vehicles are usually inclined to pay more attention to the road than to the various advertising billboards that are posted alongside the road. For example, such a billboard may be used to advertise a particular automobile. In order to attract the attention of the consumer, the billboard may contain images of the automobile along with images of attractive human models possessing varying degrees of pulchritude. Once the attention of the consumer has been attracted, the message can be conveyed. Such a message can be as simple as “Buy this car.” Usually, however, the message is intended to address the consumer's desires on several levels including the desire for comfort, the desire for companionship, the desire for elegance, the desire for an active leisure lifestyle, the desire for speed, the desire for adventure, the desire for fuel economy, the desire for open-air travel and so on. The advertisement may address combinations of consumer desires. In addition, the very image of the automobile itself may be designed to trigger certain reactions in the consumer. An example may include a sense of machismo, as conveyed by a grill designed in a specific way, a large, protruding hood, a vivid color or a wide wheel base. A further example may be a sense of femininity, conveyed by soft, coordinated colors, elegant curves luxurious interior design and so on. It is understood that the descriptions “masculine,” “machismo” or “feminine” are not limited to the sex of the customer but are merely meant to describe certain segments of the population. The message may be conveyed using images alone, written words or combinations thereof. In any case, the entire point of the advertisement must be conveyed during the few seconds in which the consumer views the billboard.

A billboard designed to attract the consumer's attention and convey a range of collateral messages having to do with lifestyle choice, self image or individual desires may leave the consumer with a strong impression, but only a vague recollection of specific details such as car model name or even brand. The message conveyed by the advertisement may nevertheless have imprinted a latent desire for the automobile, which, during a period of ideation, becomes explicit. Without more detailed knowledge of the automobile model, brand and/or dealer location or other contact information, the consumer would be unable to consummate a purchase transaction. A system of advertising retrieval would enable the consumer to obtain specific details that would be necessary to purchase the automobile.

Other visual media are available to advertisers. These include but are not limited to television, newspapers, magazines, the Internet, or any other medium capable of transmitting or displaying visual images. Visual images can be displayed in various ways and over various timescales in such a way that various levels of recall are observed in consumers, ranging from essentially complete recall to mere vague impressions. Consumers may therefore exhibit differing levels of ability to describe their experience after having viewed the advertisement. Further, other artistic visual devices can be used to covey the advertising message or make an impression on the consumer. Such devices can vary in the level of abstraction from highly explicit to highly abstract. In addition, written messages can be conveyed visually and may employ language or other devices that convey messages that range in degree of precision from highly explicit to highly ambiguous. The use of language in advertising is described further infra. It is known in the advertising art that such images evoke feelings in the consumer that are sometimes difficult to describe with precision. Hence, it would be desirable to have a heretofore-unknown means of advertising retrieval that comprises the ability to capture as input, a spectrum of customer descriptions ranging from vague or imprecise impressions to highly explicit depictions of the advertisement.

Audio media are also employed frequently in advertising. It is known in the art that various artistic and communicative devices can be used to convey and lend saliency to the advertiser's message including but not limited to the spoken word, instrumental music, vocal music naturally occurring sounds, sounds that may arise from time to time in human events and sound effects. Used alone or in combination, such devices can be employed to evoke various reactions in consumers ranging from vague impressions to highly explicit emotions.

For example, the spoken word employs a plurality of vocabularies that vary in levels of ambiguity ranging from highly ambiguous to highly explicit. It is known in the advertising art that different audiences are influenced in different ways by language, depending on interest, occupation, cultural background and other characteristics.

Further, it is known that individuals can be influenced in different ways at different times by linguistic devices. For example, an engineer may respond favorably to a message conveyed in a highly explicit vocabulary when the message pertains to matters related to his or her field of endeavor and, in contrast, would not respond well to highly evocative or poetic language conveying the same message. On the other hand, the same individual might respond well to highly evocative, ambiguous or poetic language when such language conveys a message related to personal matters such as romance, a vacation, the birth of a child, normal family activities and the like.

Ambiguity is introduced into language to encompass a range of emotions and other impressions. Such ambiguity arises because individual words and phrases usually possess some combination of connotative and denotative meaning that is known in the art to be useful in conveying a compelling message efficiently. Denotative meaning is defined as that which is explicit and highly particular. For example, the word “three” has the denotative meaning of “2+1” and communicates that concept with high precision.

On the other hand, connotative meaning is defined as that which signifies more than the literal meaning of a given word or phrase. Without intending to be bound by theory, it is believed that such meaning arises out of the cultural and contextual evolution of language. The same language can, therefore, have different impact on different demographic groups. Connotation is used frequently as a poetic element to encompass a broader range of meaning than that which might arise from denotation. The same concept is known in the art to be useful in advertising where brevity requires the use of meaning-laden words and phrases to convey a compelling message rapidly. Other terms of art such as “buzzword,” “catchphrase,” “slang,” “jargon,” “vernacular” or “colloquial speech” are all meant to convey the same or similar concept as connotative language. For example, the word “score” has the usual denotative meaning related to the accumulation of points in a game by a player or team. In addition, a person can be said to “know the score,” which means to understand clearly his or her situation. Further, one is said to have “settled the score” when a debt is paid or revenge is exacted. In addition, connotative meaning varies across cultural boundaries. For example, the word “handy” in the English language denotes that which is “at hand” or convenient. Connotatively, a “handy man” is one who is capable of doing many types of work. Such a person is said to be “handy.” Among those of recent German origin, however, the word “handy” signifies a wireless telephone.

Connotations can evoke both negative and positive reactions in consumers. While it may be desirable to avoid offending certain groups by using words that carry offensive connotative meaning, evoking a negative reaction may not always be undesirable from the standpoint of the advertiser. Such words may elicit a strong reaction in the consumer, which may be useful in inducing the consumer to remember the content of the advertisement. Nevertheless, the feelings evoked by such an advertisement may be difficult to describe in words.

It is also understood that other linguistic elements are useful in the audio presentation of advertising. Such elements include rhyme, rhythm, meter, alliteration, onomatopoeia, synecdoche, metonymy, simile, metaphor and the like. When heard in spoken form or sung, such elements can convey meaning beyond the literal meanings of the words used or attract the attention of or evoke feelings in consumers in ways that are difficult for individual customers to describe precisely.

Other forms of communication can be transmitted through audio channels and are known in the art to enhance the message conveyed in an advertisement. For example, musical elements such as harmony, rhythm, meter and the like can be used to enhance the tone and mood of an advertisement to suggest cultural identity, sense of urgency, demographic appeal, type of enjoyment and the like. For example, melodies using the pentatonic minor scale may be used to identify the product with Asian, African or Native American culture, depending on the types of rhythm that are employed in combination. On the other hand, the addition of the flatted fifth to the pentatonic minor scale, when used with syncopated rhythm, may suggest a bluesy or jazzy mood that enhances the image of the product by identifying it with being “cool” or “hip.” Nevertheless, the consumer may not be sufficiently aware of such devices to describe them precisely but may only be able to describe his or her feelings that were evoked by the advertisement.

A less frequently used, although sometimes highly effective element used in advertising is the stimulation of the olfactory sensation. A common application is in the advertising of perfumes. Frequently, olfactory queues are introduced through technologies such as scratch-and-sniff in printed publications or environmentally in entertainment venues. Odors can be powerful triggers of memory or impulses and can evoke feelings such as romance, hunger, nostalgia, or exhilaration. For example, realtors sometimes encourage their clients to bake bread just prior to the arrival of a prospective homebuyer, thus stimulating a nostalgic or home-like feeling that may increase the probability that the house will be sold. While such queues may be powerful, consumers frequently find it difficult to describe their feelings precisely when asked to do so.

Other less frequently used sensory queues include taste and texture. Textural queues are employed in advertising fabrics, carpets, and wall coverings as well as in foodstuffs. The sense of taste is used most frequently in the offer of free samples of food or drink. When familiar foods are sampled, consumers are generally able to provide reasonably precise descriptions of their experience with the sampled food. However, after sampling unfamiliar food, consumers frequently use imprecise language to describe the taste. It has been said, for example, that rattlesnake meat tastes “like chicken,” when the actual taste, based on the chemical constituents of the meat, may be very different. Customer descriptions of experiences with texture or taste may depend on cultural factors and will usually be described with varying levels of precision.

From the standpoint of the advertiser, it is necessary to reach target markets, usually comprising specific demographic populations. For products with narrow appeal, such targeting is probably sufficient to cover the contextual advertising space necessary to achieve a high level of saliency with the specific targeted population. When products have a more broad appeal, however, it may be desirable to address specific demographic populations by targeting different advertisements to different groups. Under such circumstances, each advertisement would be presented in such a way as to achieve a high level of saliency and specific positioning within the various targeted demographic populations while maintaining the desired product image and other commonalities consistently across the demographic spectrum. A heretofore-unknown system of advertising retrieval would be useful for mapping the contextual space around a given product offering and across the demographic spectrum to determine whether the desired coverage has been achieved. Furthermore, a heretofore-unknown system of advertising retrieval would be useful for mapping the contextual space around a competitor's product offering and across the demographic spectrum to determine the competitor's targeting strategy.

Thus, a system of advertisement information retrieval, heretofore unknown in the advertising art, would be desirable for the purpose of allowing consumers to recall forgotten details presented in advertisements, particularly when the attempted retrieval is not contemporaneous with the presentation of the advertisement. It is further desirable to allow consumers to use their own words, which may possess varying degrees of precision, as input to a heretofore-unknown advertisement retrieval system that retrieves specific details concerning the content of an advertisement or small numbers of advertisements, whether or not the attempted recall is contemporaneous with the presentation of the advertisement. It is further desirable to allow consumers to input their impressions of an advertisement or group of advertisements into a heretofore-unknown advertisement retrieval system that retrieves and supplies specific details that enable behaviors or actions consistent with the intention of the advertiser when such details were not present in the original advertisement(s), whether or not the retrieval is contemporaneous with the presentation of the advertisement. In addition, a system of advertising retrieval will be useful to advertisers in mapping the contextual space in which advertising messages are placed so that audiences can be targeted with greater accuracy and precision and so that competitive analysis can be performed.

### SUMMARY OF THE INVENTION

It is an object of the present invention to facilitate customer response to advertising by providing a new method of retrieving information about advertisements whether or not details concerning specific advertisements can be recalled. It is a further object of this invention to facilitate an advertiser's demographic research by providing a method of retrieving advertising information based on input of selected search terms or phrases.

The invention, therefore, according to a first broad aspect provides a method of supplying advertisement information to a user searching for desired information within a data network, comprising the steps of: receiving, from the user, one or more search rules comprising facts about an advertisement; accessing a database comprising details of a plurality of advertisements; using a search engine to apply said search rules to said database; and reporting, to the user, results comprising a subset of the contents of said database.

According to a second broad aspect, the invention provides a method of supplying advertisement information to a user searching for desired information within a data network, comprising the steps of: querying the user to obtain one or more search rules comprising facts about an advertisement; accessing a database comprising details of a plurality of advertisements; using a search engine to apply said search rules to said database to obtain a plurality of results comprising a first subset of the contents of said database; receiving one or more keywords from the user; using said keywords and said search engine to query said first subset; and reporting, to the user, results comprising a second subset of the contents of said database, wherein said second subset is smaller than said first subset.

According to a third broad aspect, the invention provides a method of supplying advertisement information to a user searching for desired information within a data network, comprising the steps of: querying the user to obtain one or more search rules comprising facts about an advertisement; accessing a database comprising details of a plurality of advertisements; using a first search engine to apply said search rules to said database to obtain results comprising a first subset of the contents of said database; receiving from the user one or more keywords; using said keywords and a second search engine to query said first subset; and reporting, to the user, results comprising a second subset of the contents of said database, wherein said second subset is smaller than said first subset.

According to a fourth broad aspect, the invention provides a method of supplying advertisement information to a user searching for desired information within a data network, comprising the steps of: querying the user to obtain one or more search rules comprising facts about an advertisement; accessing a database comprising details of a plurality of advertisements; using a search engine to apply said search rules to said database to obtain a plurality of results comprising a first subset of the contents of said database; receiving, from the user, a first list of keywords; generating a second list of keywords, said second list comprising keywords synonymously related to one or more keywords in said first list; using said second list and a second search engine to query said first subset; and reporting, to the user, results comprising a second subset of the contents of said database, wherein said second subset is smaller than said first subset.

According to a fifth broad aspect, the invention provides a method of supplying advertisement information to a user searching for desired information within a data network, comprising the steps of: querying the user to obtain one or more search rules comprising facts about an advertisement; accessing a database comprising details of a plurality of advertisements; using a first search engine to apply said search rules to said database to obtain a plurality of results comprising a first subset of the contents of said database; receiving, from the user, a first list of keywords; generating a second list of keywords, said second list comprising keywords or phrases synonymously related to one or more keywords or phrases in said first list; using said second list and a second search engine to query said first subset; and reporting, to the user, results comprising a second subset of the contents of said database, wherein said second subset is smaller than said first subset.

According to a sixth broad aspect, the invention provides a method of facilitating demographic research by supplying advertisement information to a user searching for information within a data network, comprising the steps of: receiving a set of search terms comprising words having targeted connotative significance to a particular demographic segment; accessing a database comprising details of a plurality of advertisements; using a search engine to apply said search terms to said database; and reporting results comprising a subset of the contents of said database.

According to a seventh broad aspect, the invention provides a method of performing demographic analysis of advertisements, comprising the steps of: (a) receiving a list of search terms comprising words having connotative significance to a targeted demographic segment; (b) accessing a database comprising details of a plurality of advertisements; (c) using a search engine to apply said list of search terms to said database; (d) reporting results of the search comprising a subset of the contents of said database said results being indexed uniquely; and (e) repeating steps (a)-(d) a number of times with at least one different search term in said list, said number being sufficient to cover the desired demographic space.

In each of the above broad aspects of the invention, the data network can be a private network, accessed by authorized persons, or a public network such as the Internet. The private network can be accessed via the Internet, using secure connection technology, such as encryption, password protected access or recognition of unique user identifiers such as, but not limited to personal details, fingerprints, retinal data, voice characteristics and the like. The public network can be the Internet or any other network available to the general public. Public or private networks can be accessed using a computer terminal, a personal computer interface, a public kiosk interface which might be found in a shopping venue or roadway rest stop or a wireless device such as a wireless telephone or a wireless Internet interface. The search engines of this invention can reside on a central host computer, a server, a plurality of mirror sites or locally on the user's computer. The advertisement database of this invention can reside on a central host computer, a server, a plurality of mirror sites or locally on the user's computer. The advertisement database can be built for purposes this invention, assembled from various dispersed sources on the Internet into a single database or directed from a list of pointers to various dispersed sources on the Internet.

The search rules supplied by the user need not be sufficiently complete to define a particular advertisement uniquely. Search rules can comprise keywords or phrases describing the advertisement in some way, brand names or portions thereof, “soundalike” or misspelled words capable of being interpreted by the search engine and applied to the database, a description of color schemes used in the advertisement, a description of the music heard in the advertisement, a description of the linguistic elements employed by the advertisement, a description of the ambient environment depicted in the advertisement, a description of the user's subjective impression after experiencing the advertisement, a description of visual queues perceived in the advertisement, a description of the plant, animal or human model or models used in the advertisement, a description of the cartoon or caricatured models used in the advertisement, a description of the item advertised, a description of the social situation depicted in the advertisement, a description of the tactile sensations conveyed by the advertisement, a description of the olfactory sensations conveyed by the advertisement, a description of the taste sensations presented by the advertisement, a description of the user's perception triggered by a sensory stimulus or a plurality of stimuli conveyed by the advertisement or a description of the user's impressions of the artistic elements presented in the advertisement or other descriptors characteristic of the advertisement. For purposes of the description of this invention, keywords can be single words, phrases that are not full sentences or full interrogative, declarative or imperative sentences or any combination thereof. In the cases where a given keyword input by the user comprises a multiword phrase or a complete sentence, one of ordinary skill in the art would recognize that such phrases or complete sentences can be parsed to yield relevant single keywords using methods described in standard references such as James Allen, “Natural Language Understanding,” Addison Wesley, New York, (1995), Chapters 2,3,6 and 7.

Search rules and keywords or phrases can be input by typing; spoken into a voice recognition system capable of interpreting the input for the search engine; entered via a user interface comprising a pad having one or more real or virtual keys such as a typewriter keyboard, a telephone keypad, or a touch screen; an electronic musical instrument; a handwriting recognition interface; a mouse; an eye movement sensor; or any other indicative means employed in computer interfaces.

The connotative and denotative meanings of words and phrases can be tabulated and used to expand a keyword list, presented by the user to describe his or her experience with an advertisement, so that a larger, more inclusive list is generated. For the purposes of this specification, an expanded list can be described alternatively as a list of terms synonymously related to one another. To generate an expanded list or list of synonyms, such data as is contained in “Partridge's Concise Dictionary of Slang and Unconventional English,” Macmillan Publishing Company, New York, (1984 edition), and/or “Roget's International Thesaurus,” Robert L. Chapman (Editor), HarperCollins, (1992 edition) can be used.

The database can be input, updated and/or modified by a database administrator, an advertiser or the advertiser's agent or media outlet, or experientially using the search engine. Furthermore, the database can reside on a server or locally at the user interface. The search engine algorithm can be similar to those used on the Internet such as might be provided by Google, Lycos or AltaVista; free-form or query-based using deductive reasoning in a manner similar to that used in the game “Twenty Questions;” query or free-form input based using abductive reasoning as described in U.S. Pat. No. 5,812,994, incorporated herein by reference, fuzzy logic searching, described in references such as Jerry M. Mendel, “Uncertain Rule-Based Fuzzy Logic Systems: Introduction and New Directions,” (Prentice-Hall, 2000) or can be any other algorithm that uses search and/or sorting techniques described in standard references such as Donald E. Knuth, “The Art of Computer Programming Vol. 3,” (Addison-Wesley Publishing, Co. 1973). A person skilled in the art will recognize that the database can be searched using a simple sequential search, a hierarchical search or other searching algorithms. Alternatively, the database directory can be implemented as a hash table with hash computations operable to locate a block of data in the directory. In addition, combinations comprising a plurality of search techniques can be employed. For example, a search using query-based deductive reasoning can be used in combination with a keyword search to yield a subset of the advertisement database. As another example, a search using abductive reasoning can be applied initially, followed by a deductive keyword search of the inferential hypotheses generated by the abducer to yield a subset of the advertisement database.

Results can be reported to the user via a standard display interface such as a video screen, a Braille interface, a voiced interface using real, recorded or synthesized voice, or any other indicative means.

Search results can be in the form of contact information to enable the user to contact the advertiser or the advertiser's designee, a synopsis of the advertisement, a copy of the advertisement, a replay of the advertisement, or a recitation any portion of the advertisement copy. In addition, combinations of the above can be supplied.

In iterative searches, results are indexed with a unique identifier denoting each of several unique lists of search terms. Such results can, for example, be used to map demographic audiences, targeted in each iteration, to the corresponding search results so that the advertiser can evaluate his or her advertising coverage or that of his or her competitor.

### BRIEF DESCRIPTION OF THE DRAWINGS

Crossed lines do not indicate connection. Collinear segments indicate input to the same point or output from the same point. Arrowheads pointing into an element indicate input whereas arrowheads pointing away from an element indicate output.

FIG. 1 shows a schematic outlining the most basic concept of the invention.

FIG. 2 shows an embodiment of invention in which information is input by the user based on queries form the advertisement retrieval system. Either a plurality of results or a single result is communicated to the user, depending on whether the input data defines an advertisement uniquely.

FIG. 3 is the same as FIG. 2 except that multiple results are input to a second search phase represented in FIG. 4.

FIG. 4 represents a second search phase when the output from the search of FIG. 3 does not produce a unique result. Input to FIG. 4 is the non-unique result from the search of FIG. 3 and a list of keywords entered by the user.

FIG. 5 is the same as FIG. 4 except that the input keyword list is expanded to comprise the original keywords and synonyms derived from the original list.

FIG. 6(A-H) represents an interactive session in which the user is seeking information about a pharmaceutical product.

### DETAILED DESCRIPTION

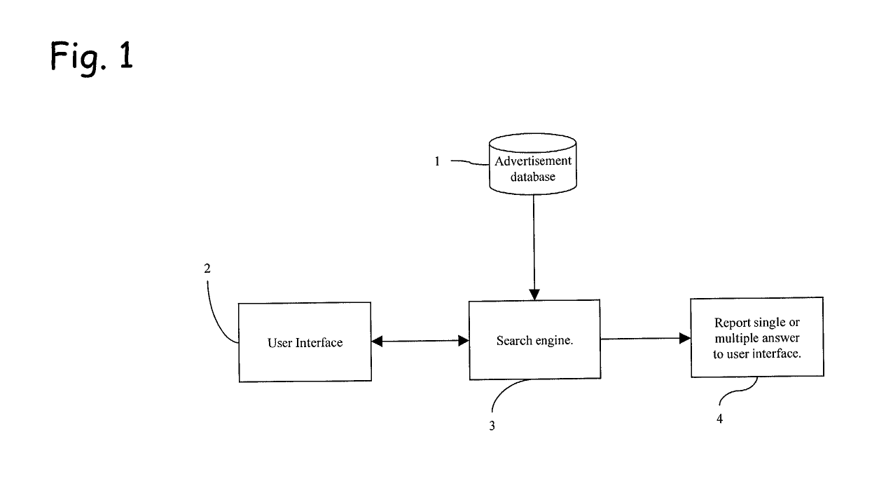

FIG. 1 shows the basic design for this invention. Shown are (1) an advertisement database comprising data about a plurality of advertisements, (2) a user interface with an input portion and an output portion, (3) a search engine, capable of accepting input from the user, querying the advertisement database and (4) reporting a single result or a plurality of results to the user via the user interface wherein the results comprise a subset of the advertisement database.

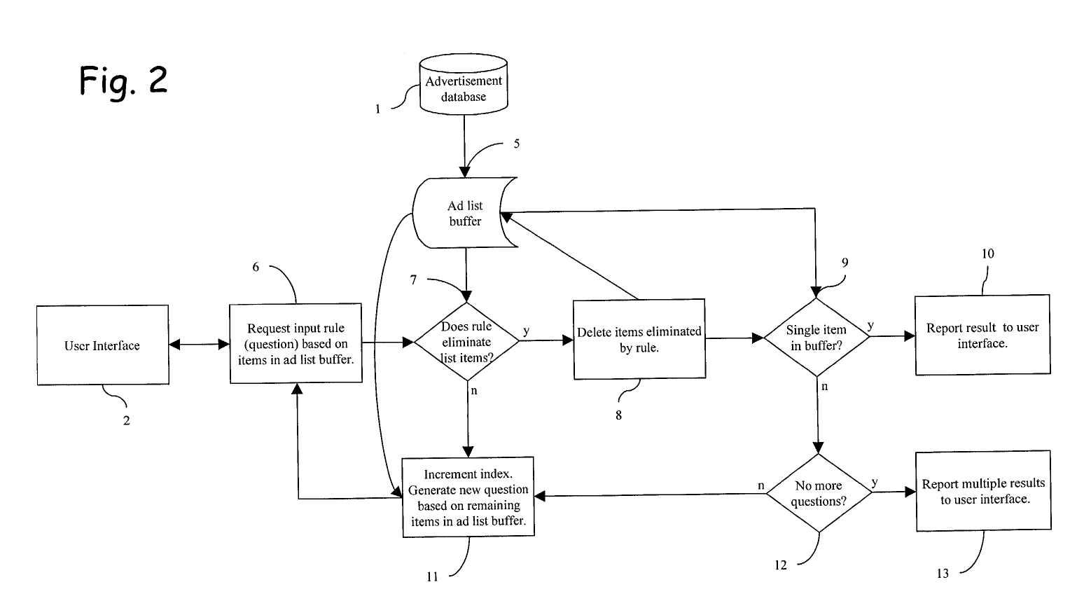

FIG. 2 shows this invention with the search engine implemented to eliminate from consideration in an iterative fashion those advertisement records that do not meet the search criteria. As before, FIG. 2 shows, (1) the advertisement database and (2) the user interface. Data from (1) are copied initially into (5) an ad list buffer. The user is queried by (6) for an input rule, which is then passed to (7) a decision point. If the rule, input by the user, can eliminate one or more records in the ad list buffer, a command is passed to (8), which deletes items based on the input rule. If the rule, input by the user, can not eliminate a record in the ad list buffer, a command is passed to (11), which increments an index denoting the number of questions that have been asked, generates a new question based on the data in the ad list buffer and passes the new question back to (6), which reinitiates the process with a new query to the user. Once at least one record is deleted from (5) by (8), a query is made by (9), a decision point, to determine whether there is only one item left in the ad list buffer. If so, a single result has been generated. That result is communicated by (10) to the user interface and passed to the user. If not, an argument is communicated to (12) another decision point, which determines whether there are no further questions to be asked of the user. If there are no further questions, (13) passes the remaining results to the user via the user interface, (2). If there are more questions to be asked, a command is passed to (11), which increments an index denoting the number of questions that have been asked, generates a new question based on the data in the ad list buffer and passes the new question back to (6). Thus, the process is iterated until a single record remains in the ad list buffer or there are no further questions.

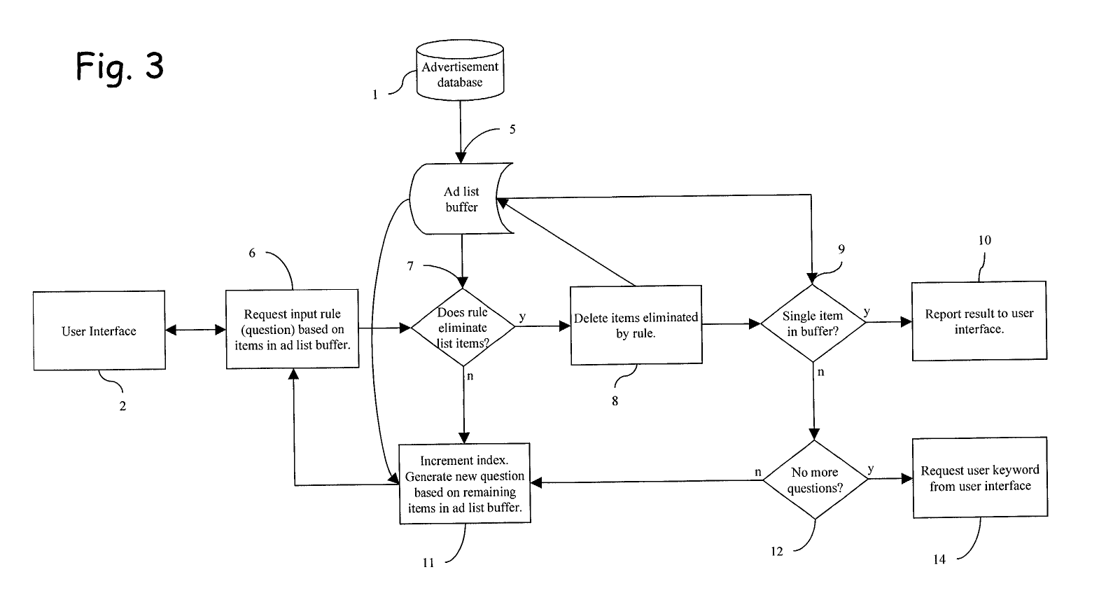

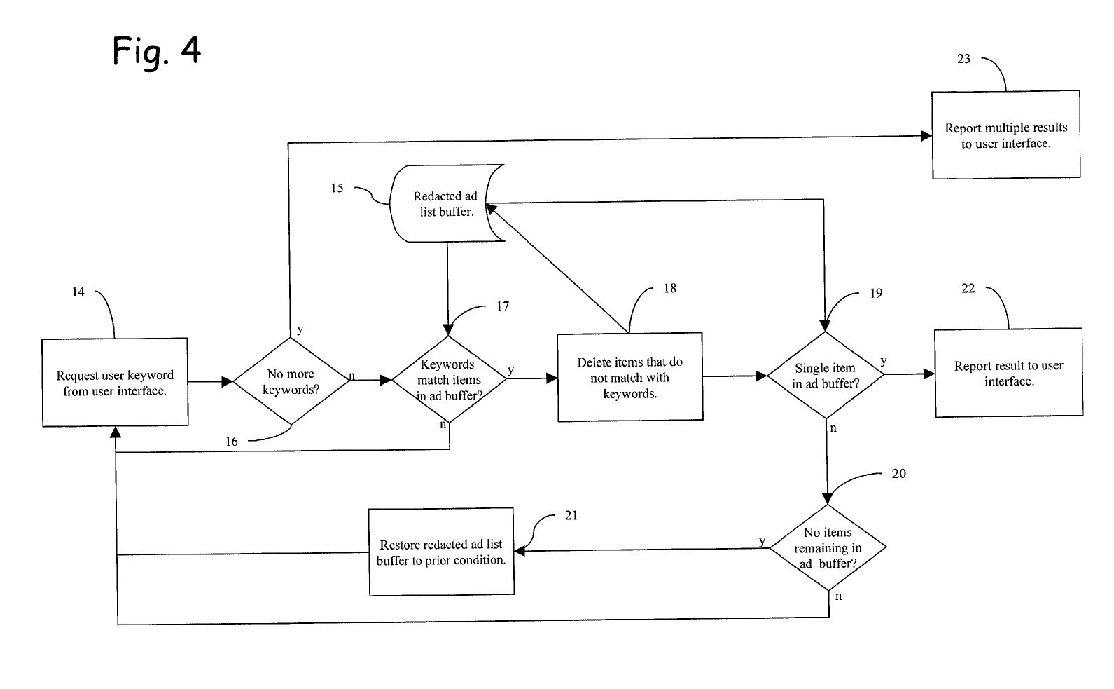

FIG. 3 is similar to FIG. 2 except that the multiple results are not reported to the user at (13). The process, (14), requests from the user, a free-form keyword via the user interface. The new keyword is passed to the process of FIG. 4.

The process of FIG. 4 uses keywords entered in freeform at (14) that is tested to determine whether it matches any of the items in (15) the redacted ad list buffer. The output of (14) is first passed through (16) a decision point that determines whether all of the keywords from (14) have been exhausted. If there are no keywords pending, the contents of (15) are passed to (23) and reported to the user via the user interface. If at least one keyword is pending, it is passed to (17) a decision point which queries whether the pending keyword matches any of the items in the ad buffer. Upon finding one or more matches, the redacted ad list buffer (15) is redacted further by removing those advertisement records that do not match the pending keyword. If (17) determines that no match with the pending keyword was found, a new keyword is requested at (14). The process of (18) passes to (19) a decision point that determines whether the ad list buffer contains a single item. If the ad list buffer contains a single item, the result is reported by (22) to the user via the user interface. If no items or more than one item is contained in the ad list buffer, control is passed to (20) a decision point which determines whether the redacted ad list buffer is empty. If the redacted ad list buffer is empty, control is passed to (21) which restores the redacted ad list buffer to its condition prior to testing by the last keyword and then passes control to (14). If at (20) the redacted ad list buffer contains more than one item, control is passed to (14). Thus, the process is iterated until a single record remains in the redacted ad list buffer or there are no further keywords from the user.

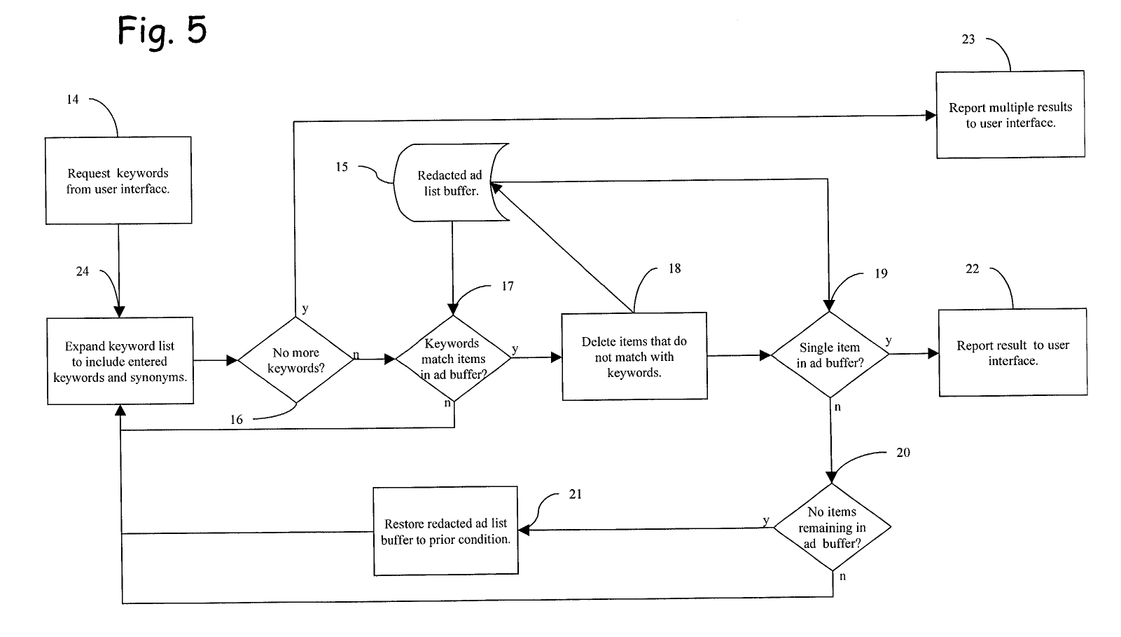

FIG. 5 is similar to FIG. 4 except that the input of a keyword at (14) passes control to (24) which expands the input of each keyword, if possible, to include the original keyword and its synonyms. Thus, the process of FIG. 5 is iterated until a single record remains in the redacted ad list buffer or there are no further keywords or synonyms to be tested.

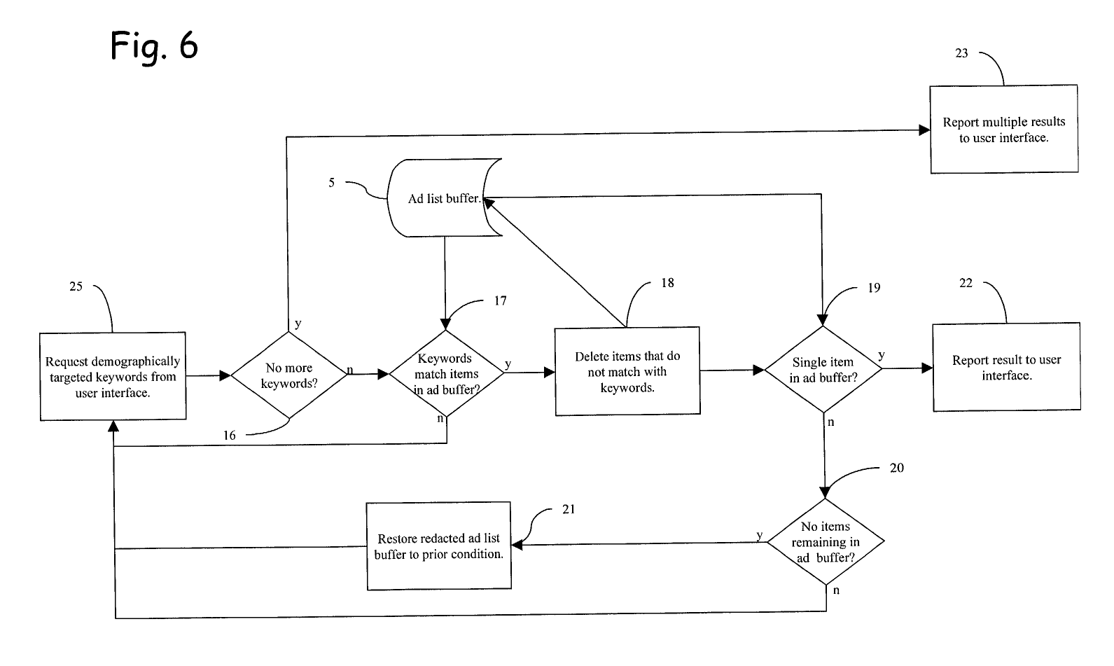

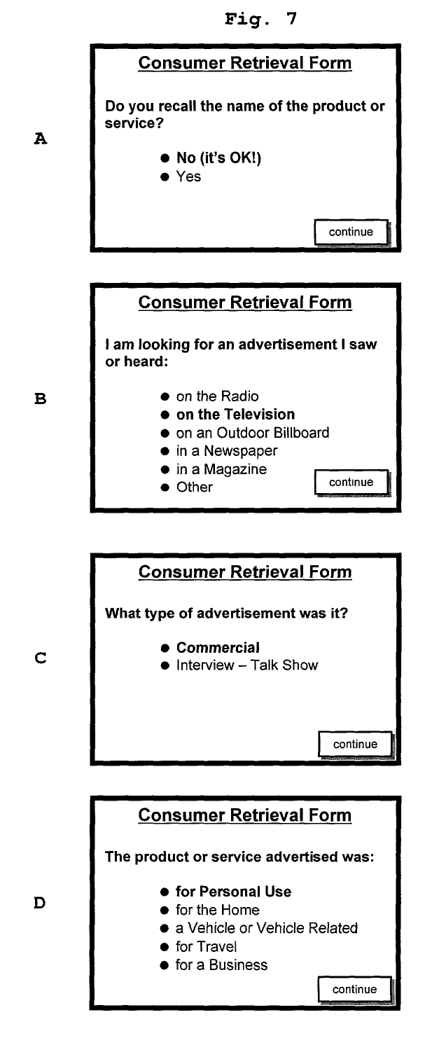

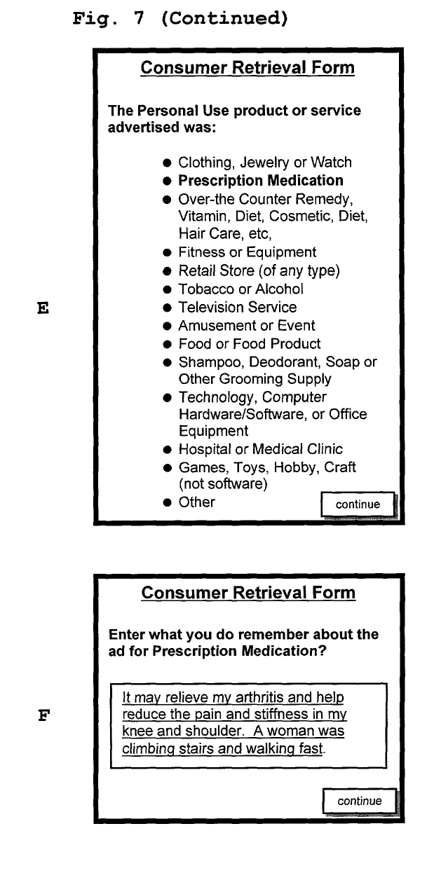

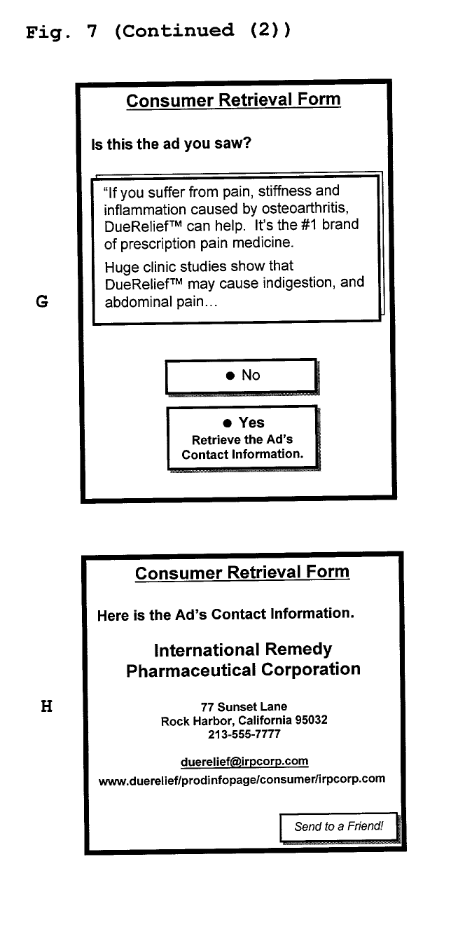

FIG. 6 is similar to FIG. 4 except that (25) requests search terms that are targeted at a single demographic group or a subset of the demographic universe and that the process is begun with the full ad list buffer (5) initially comprising all of the records in the entire advertisement database.

FIG. 7A-H describes an interactive session with the advertisement retrieval program. The underlying algorithm for this session is that described in FIGS. 3 and 4. FIG. 7(A) shows that the program makes no assumptions about the contents of the advertisement experienced by the user. In fact, the user need not even remember the name of the product or service. FIG. 7(B) provides a basis for eliminating from consideration all of the advertisements in the database except those presented on television. FIG. 7(C) indicates that the user further eliminates from consideration all messages such as talk shows or interviews that were not presented as a commercial. FIG. 7(D) indicates that the advertised product is for personal use, thus eliminating from consideration all advertisements for the home, for business, for travel or for vehicle related products. FIG. 7(E) indicates that the product is a prescription medication, thus eliminating all items that are not prescription medications. FIG. 7(F) requests free-form input from the user indicating that the medication is for relieving pain from arthritis and a salient detail about the ad, namely, that a woman was “climbing stairs and walking fast.”

FIG. 7(G) indicates that the system now has sufficient information to suggest the contents of a single result, which is recognized by the user. FIG. 7(H) reports the single result to the user in the form of contact information.

### EXAMPLES

### Example 1

In this hypothetical example, Fred has arthritis in his knees and in his shoulder to the extent that he finds it difficult to drive his car to work. One weekend afternoon, while he was napping on his living room couch a commercial on television described a new, highly effective arthritis medication called “DueRelief,” which was advertised as a prescription medicine. Fred was able to recall only bare details about the advertisement. Fred had seen advertisements for other prescription medications before and had requested them from his physician only to find that the previously advertised medications were not right for him. The only mention of side effects in the advertisement indicated that DueRelief might cause abdominal pain. Armed with very little information, Fred was able to enter the advertisement retrieval system, answer a few simple questions and obtain the contact information he needed for the makers of DueRelief. He went to the website of International Remedy Pharmaceutical Corporation where he was able to find that DueRelief was contraindicated for those patients who had recently been exposed to chicken pox or shingles or had alcoholic liver disease but was otherwise safe and effective. Since Fred had not recently been exposed to chicken pox or shingles and only drank alcohol occasionally, it appeared that DueRelief might be a good choice for him. Fred consults his physician.

### Example 2

An advertising campaign shows a particularly attractive automobile but explicitly and intentionally does not supply sufficient information to consummate a purchase. The customer must be out of the country for several weeks and is concerned that upon her return the ad campaign will have run its course and she will not have sufficient information to buy the automobile. Upon entering the advertising retrieval system, she is able to enter what she can remember about the ads seen in the ad campaign until the present time. The advertising retrieval system recovers contact information about the advertisement but does not deliver it immediately in keeping with the spirit of the advertising campaign. Rather, the company sends the customer an electric mail message when it is ready to divulge the desired contact information.

### Example 3

A small storeowner features various items at a reduced price each week. He has a limited advertising budget and wants to make his advertisements as productive as possible. While he believes that people pay little attention to advertising at the time an advertisement is presented, he is also convinced that people who follow through by making the effort to use the advertising retrieval system are more strongly motivated to buy the advertised products. The storeowner pays to have his ads listed on the advertisement retrieval system before they run so that customers can search for his ads at their leisure.

Those skilled in the art will realize that various modifications, adaptations and alterations to the present invention are possible in light of the above teachings. It should therefore be understood at this time that, within the scope of the appended claims, the invention may be practiced otherwise than was described specifically hereinabove. For example, although the search engine described above is readily implemented in software, the invention does not exclude the possibility of implementing the search engine in hardwired form or in a combination of software and hardwired logic.

What is claimed is:

1. A method of supplying advertisement information to a user searching for said information within a data network, comprising the steps of: receiving, from the user, a series of search rules comprising facts about an advertisement; accessing a database comprising details of a plurality of advertisements; using a search engine to apply said search rules to said database; and reporting, to the user, results comprising a subset of the contents of said database.

2. The method of claim 1 wherein the user experienced said advertisement previously.

3. The method of claim 1 wherein the data network comprises the Internet.

4. The method of claim 1 wherein the algorithm of said search engine is selected from a group consisting of deductive reasoning, fuzzy logic and abductive reasoning.

5. The method of claim 1 wherein said advertisement information comprises contact information.

6. The method of claim 1 wherein said user is a customer.

7. The method of claim 6 wherein the customer experienced said advertisement previously.

8. The method of claim 6 wherein the data network comprises the Internet.

9. The method of claim 6 wherein the algorithm of said search engine is selected from a group consisting of deductive reasoning, fuzzy logic and abductive reasoning.

10. The method of claim 6 wherein said advertisement information comprises contact information.

11. A method of supplying advertisement information to a user searching for desired information within a data network, comprising the steps of: querying the user to obtain one or more search rules comprising facts about an advertisement; accessing a database comprising details of a plurality of advertisements; using a first search engine to apply said search rules to said database to obtain results comprising a first subset of the contents of said database; receiving from the user one or more keywords; using said keywords and a second search engine to query said first subset; and reporting, to the user, results comprising a second subset of the contents of said database, wherein said second subset is smaller than said first subset.

12. The method of claim 11 wherein said user experienced said advertisement previously.

13. The method of claim 11 wherein the data network comprises the Internet.

14. The method of claim 11 wherein the algorithm of said first search engine is selected from a group consisting of deductive reasoning, fuzzy logic and abductive reasoning.

15. The method of claim 11 wherein the algorithm of said second search engine is selected from a group consisting of deductive reasoning, fuzzy logic and abductive reasoning.

16. The method of claim 11 wherein the algorithm of said first search engine is the same as the algorithm of said second search engine.

17. The method of claim 11 wherein said advertisement information comprises contact information.

18. The method of claim 11 wherein said user is a customer.

19. The method of claim 18 wherein said customer experienced said advertisement previously.

20. The method of claim 18 wherein the data network comprises the Internet.

21. The method of claim 18 wherein the algorithm of said first search engine is selected from a group consisting of deductive reasoning, fuzzy logic and abductive reasoning.

22. The method of claim 18 wherein the algorithm of said second search engine is selected from a group consisting of deductive reasoning, fuzzy logic and abductive reasoning.

23. The method of claim 18 wherein the algorithm of said first search engine is the same as the algorithm of said second search engine.

24. The method of claim 18 wherein said advertisement information comprises contact information.

25. A method of supplying advertisement information to a user searching for desired information within a data network, comprising the steps of: querying the user to obtain one or more search rules comprising facts about an advertisement; accessing a database comprising details of a plurality of advertisements; using a first search engine to apply said search rules to said database to obtain a plurality of results comprising a first subset of the contents of said database; receiving, from the user, a first list of keywords; generating a second list of keywords, said second list comprising keywords or phrases synonymously related to one or more keywords or phrases in said first list; using said second list and a second search engine to query said first subset; and reporting, to the user, results comprising a second subset of the contents of said database, wherein said second subset is smaller than said first subset.

26. The method of claim 25 wherein said user experienced said advertisement previously.

27. The method of claim 25 wherein the data network comprises the Internet.

28. The method of claim 25 wherein the algorithm of said first search engine is selected from the group consisting of deductive reasoning, fuzzy logic and abductive reasoning.

29. The method of claim 25 wherein the algorithm of said second search engine is selected from the group consisting of deductive reasoning, fuzzy logic and abductive reasoning.

30. The method of claim 25 wherein the algorithm of said first search engine is the same as the algorithm of said second search engine.

31. The method of claim 25 wherein said advertisement information comprises contact information.

32. The method of claim 25 wherein said user is a customer.

33. The method of claim 32 wherein said customer experienced said advertisement previously.

34. The method of claim 32 wherein the data network comprises the Internet.

35. The method of claim 32 wherein the algorithm of said first search engine is selected from the group consisting of deductive reasoning, fuzzy logic and abductive reasoning.

36. The method of claim 32 wherein the algorithm of said second search engine is selected from the group consisting of deductive reasoning, fuzzy logic and abductive reasoning.

37. The method of claim 32 wherein the algorithm of said first search engine is the same as the algorithm of said second search engine.

38. The method of claim 32 wherein said advertisement information comprises contact information.

39. A method of facilitating demographic research by supplying advertisement information to a user searching for information within a data network, comprising the steps of: receiving a set of search terms comprising words having targeted connotative significance to a particular demographic segment; accessing a database comprising details of a plurality of advertisements; using a search engine to apply said search terms to said database; and reporting results comprising a subset of the contents of said database.

40. The method of claim 39 wherein said user is an advertiser.

41. The method of claim 39 wherein the algorithm of said search engine is selected from a group consisting of deductive reasoning, abductive reasoning and fuzzy logic.

42. A method of performing demographic analysis of advertisements, comprising the steps of: (a) receiving a list of search terms comprising words having connotative significance to a targeted demographic segment; (b) accessing a database comprising details of a plurality of advertisements; (c) using a search engine to apply said list of search terms to said database; (d) reporting results of the search comprising a subset of the contents of said database, said results being indexed uniquely; and (e) repeating steps (a)-(d) a number of times with at least one different search term in said list, said number being sufficient to cover the desired demographic space.

43. The method of claim 42 wherein the algorithm of said search engine is selected from a group consisting of deductive reasoning, abductive reasoning and fuzzy logic.
